(19) United States
(12) Patent Application Publication
(10) Pub. No.: US 2016/0306232 A1
(43) Pub. Date: Oct. 20, 2016

(54) CURVED LIQUID CRYSTAL DISPLAY

(71) Applicant: Samsung Display Co., Ltd., Yongin-si (KR)

(72) Inventor: Se Joon OH, Suwon-si (KR)

(21) Appl. No.: 14/923,109

(22) Filed: Oct. 26, 2015

(30) Foreign Application Priority Data
Apr. 16, 2015 (KR) 10-2015-0053925

(51) Int. Cl. G02F 1/1337; G02F 1/1362; C09K 19/30; G02F 1/1368

(52) U.S. Cl. CPC G02F 1/133711; G02F 1/133788; G02F 1/1368; G02F 1/136209; C09K 19/3003; G02F 2001/136222; C09K 2019/3004

(57) ABSTRACT

A curved liquid crystal layer is provided. The curved liquid crystal display includes a first substrate; a second substrate opposite to the first substrate; and a liquid crystal layer comprising liquid crystal molecules interposed between the first and second substrates, wherein the liquid crystal molecule is represented by Chemical Formula 1 and contained in a content of not less than 5 wt % based on the liquid crystal layer. The definition of Chemical Formula 1 is as described in the specification.

### CLAIM OF PRIORITY

This application claims the priority of and all the benefits accruing under 35 U.S.C. §119 of Korean Patent Application No. 10-2015-0053925 filed in the Korean Intellectual Property Office (KIPO) on Apr. 16, 2015, the entire contents of which are incorporated herein by reference.

### BACKGROUND OF THE INVENTION

1. Field of the Invention

The present invention relates to a curved liquid crystal display.

2. Description of the Related Art

Liquid crystal displays are one of the most widely used flat panel displays today. Typically, a liquid crystal display includes two display panels on which electric field generating electrodes, such as a pixel electrode and a common electrode, are formed, and a liquid crystal layer formed therebetween. The liquid crystal display generates an electric field in the liquid crystal layer by applying a voltage to the electric field generating electrodes, determines the alignment of liquid crystal molecules of the liquid crystal layer through the generated electric field, and displays an image by controlling the polarization of incident light.

As liquid crystal displays are used as display devices of television receivers, the sizes of their screens are increasing. Since the size of the liquid crystal displays increase as described above, a problem occurs in that the visual difference increases between when a viewer sees a central portion of a screen and when the viewer sees both left and right ends of the screen. In order to compensate for such a visual difference, the liquid crystal displays can be formed in curved shapes by bending the display devices in concave shapes or convex shapes. When a flat-panel liquid crystal display is being bent in order to prepare such a curved liquid crystal display, a stress is applied to a liquid crystal layer interposed between two substrates, and therefore a misalignment of liquid crystals occurs. Accordingly, the transmittance of the liquid crystal display is partially changed, and stains may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a curved liquid crystal display that suppresses a change in alignment of liquid crystals, thereby reducing the occurrence of stains and improving the contrast ratio.

Liquid crystal displays are one of the most widely used flat panel displays today. Typically, a liquid crystal display includes two display panels on which electric field generating electrodes, such as a pixel electrode and a common electrode, are formed, and a liquid crystal layer formed therebetween. The liquid crystal display generates an electric field in the liquid crystal layer by applying a voltage to the electric field generating electrodes, determines the alignment of liquid crystal molecules of the liquid crystal layer through the generated electric field, and displays an image by controlling the polarization of incident light.

As liquid crystal displays are used as display devices of television receivers, the sizes of their screens are increasing. Since the size of the liquid crystal displays increase as described above, a problem occurs in that the visual difference increases between when a viewer sees a central portion of a screen and when the viewer sees both left and right ends of the screen. In order to compensate for such a visual difference, the liquid crystal displays can be formed in curved shapes by bending the display devices in concave shapes or convex shapes. When a flat-panel liquid crystal display is being bent in order to prepare such a curved liquid crystal display, a stress is applied to a liquid crystal layer interposed between two substrates, and therefore a misalignment of liquid crystals occurs. Accordingly, the transmittance of the liquid crystal display is partially changed, and stains may occur.

An exemplary embodiment of the present invention provides a curved liquid crystal display, including a first substrate; a second substrate opposite to the first substrate; and a liquid crystal layer comprising liquid crystal molecules interposed between the first and second substrates, wherein the liquid crystal layer contains not less than 5 wt % of the liquid crystal molecule represented by the following Chemical Formula 1:

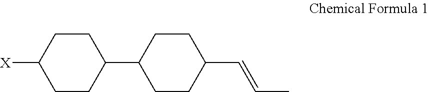

where X is a hydrogen atom, a hydroxyl group, a substituted or unsubstituted amino group, a halogen atom, an oxygen atom, a substituted or unsubstituted C1 to C30 alkyl group, a substituted or unsubstituted C6 to C30 aryl group, a substituted or unsubstituted C1 to C30 alkoxy group, a substituted or unsubstituted C3 to C30 cycloalkenyl group, a substituted or unsubstituted C1 to C20 alkylamine group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C1 to C4 alkyl ether group, a substituted or unsubstituted C7 to C20 arylakylene ether group, a substituted or unsubstituted C1 to C30 haloalkyl group, or a combination thereof.

The curved liquid crystal display may have a band elasticity coefficient K33 of liquid crystals, which is not less than 15.7×10-¹² N, in a vertical aligned (VA) mode.

The curved liquid crystal display may have a twist elasticity coefficient K22 of liquid crystals, which is not less than 7.7×10⁻¹² N, in an in-plane switching (IPS) mode.

The curved liquid crystal display may further include field generating electrodes formed on at least one of the first and second substrates.

The curved liquid crystal display may further include an alignment layer located over the field generating electrodes. The alignment layer may include an aligning agent and an aligning polymer, and the aligning polymer may be formed by irradiating light onto the aligning agent and an alignment auxiliary agent.

The first substrate may be a thin film transistor substrate and the second substrate may be a common electrode substrate, and at least one of a color filter and a black matrix may be formed on the thin film transistor substrate.

The field generating electrode may include pixel electrodes located on the first substrate and a common electrode located on the second substrate. The pixel electrode may include first cutouts and the common electrode may include second cutouts, and the first cutouts may be arranged to cross the second cutouts.

The liquid crystal molecules may be horizontally or vertically aligned in a state in which no electric field is applied.

In Chemical Formula 1, X may be hydrogen, a substituted or unsubstituted C1 to C30 alkyl group, a substituted or unsubstituted C6 to C30 aryl group, a substituted or unsubstituted C1 to C30 alkoxy group, or a combination thereof.

As described above, according to an exemplary embodiment of the present invention, it is possible to implement a curved liquid crystal display having a liquid crystal layer that contains at least a predetermined level of content of the liquid crystal molecules represented by the Chemical Formula 1, so that an misalignment of liquid crystals is suppressed, thereby reducing the occurrence of stains.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an oblique view of curved liquid crystal display according to an exemplary embodiment of the present invention.

FIG. 2 is an equivalent circuit diagram showing a pixel of a liquid crystal display according to an exemplary embodiment of the present invention.

FIG. 3 is a plan view showing a liquid crystal display according to an exemplary embodiment of the present invention.

FIG. 4 is a cross-sectional view taken along cross-sectional line III-III in FIG. 3.

FIG. 5 is a layout view showing a liquid crystal display according to an exemplary embodiment of the present invention.

FIG. 6 is a cross-sectional view taken along line V-V of FIG. 5.

FIG. 7 is an equivalent circuit diagram showing a pixel for the liquid crystal display shown in FIG. 5.

FIG. 8 is an equivalent circuit diagram showing a pixel of a liquid crystal display according to an exemplary embodiment of the present invention.

FIG. 9 is a color photographic image showing light leakage of a curved liquid crystal display including a liquid crystal layer containing less than 5 weight % of a liquid crystal molecule represented by the above Chemical Formula 1.

FIG. 10 is a drawing showing light leakage of a curved liquid crystal display including a liquid crystal layer containing not less than 5 weight % of the liquid crystal molecule represented by the above Chemical Formula 1.

FIG. 11A is a reference view illustrating degrees where the contrast ratios of the curved liquid crystal display and FIG. 11B is the curved liquid crystal display improved.

### DETAILED DESCRIPTION OF THE INVENTION

Exemplary embodiments of the present invention will be described in detail with reference to the accompanying drawings. The present invention should not be construed as limited to the exemplary embodiments set forth herein, and may be modified in various different ways. Rather, these exemplary embodiments are provided so that this disclosure will be thorough and complete, and will fully convey the scope of the invention to a person of ordinary skill in the art.

In the drawings, the thickness of layers, films, panels, regions, etc., are exaggerated for clarity. It will be understood that when a layer is referred to as being “on” another layer or a substrate, it can be directly on the other layer or the substrate, or a third layer may be interposed therebetween. Like reference numerals designate like constituent elements throughout the specification.

Unless a specific definition is otherwise provided in this specification, the term “substituted” refers to one substituted with a substituent selected from a halogen atom, a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or salts thereof, a sulfonic acid group or salts thereof, a phosphoric acid group or salts thereof, a C1-C20 alkyl group, a C2-C20 alkenyl group, a C2-C20 alkynyl group, a C6-C30 aryl group, a C7-C30 arylalkyl group, a C1-C30 alkoxy group, a C1-C20 heteroalkyl group, a C2-C20 heteroaryl group, a C3-C20 heteroarylalkyl group, a C3-C30 cycloalkyl group, a C3-C15 cycloalkenyl group, a C6-C15 cycloalkynyl group, a C2-30 heterocycloalkyl group, and a combination thereof.

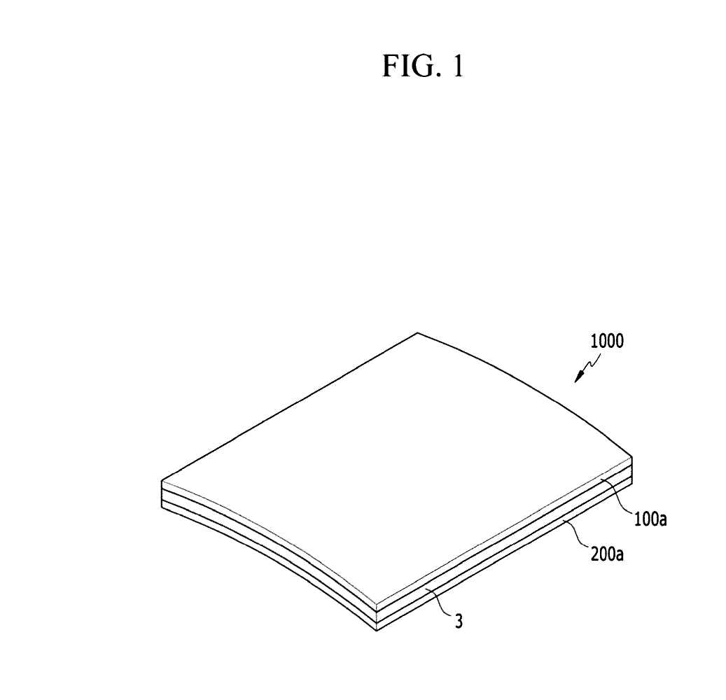

A curved liquid crystal display according to an exemplary embodiment of the present invention will be described with reference to FIG. 1. FIG. 1 is a perspective view of a curved liquid crystal display according to an exemplary embodiment of the present invention.

Referring to FIG. 1, a curved liquid crystal display 1000 according to the present exemplary embodiment includes a first substrate 100a, a second substrate 200a, and a liquid crystal layer 3. The first and second substrates 100a and 200a face each other and the liquid crystal layer 3 is provided between the two substrates 100a and 200a.

A cell gap should be reduced or liquid crystal properties should be improved in order to ensure high speed response of a liquid crystal display. Examples of the liquid crystal properties may include rotational viscosity and elasticity coefficient.

In the case where the response speed is increased by reducing the cell gap, even though a retardation of a liquid crystal layer is compensated by using liquid crystal having a high refractive index, there are problems in terms of quality and process, such as a reduction in yield and an increase in recognition of stains caused by foreign particles. Accordingly, the physical properties of the liquid crystal can be improved so that the elasticity coefficient is increased.

In the present exemplary embodiment, the composition of liquid crystal molecules can be designed such that the elasticity coefficient is improved by using a predetermined content or more of a predetermined liquid crystal molecule. In particular, the curved liquid crystal display 1000 according to an exemplary embodiment of the present invention includes an entire liquid crystal layer 3 that contains not less than 5 wt % of the liquid crystal molecule represented by the following Chemical Formula 1:

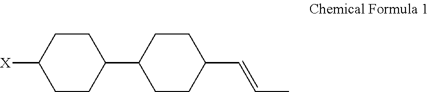

where X is a hydrogen atom, a hydroxyl group, a substituted or unsubstituted amino group, a halogen atom, an oxygen atom, a substituted or unsubstituted C1 to C30 alkyl group, a substituted or unsubstituted C6 to C30 aryl group, a substituted or unsubstituted C1 to C30 alkoxy group, a substituted or unsubstituted C3 to C30 cycloalkenyl group, a substituted or unsubstituted C1 to C20 alkylamine group, a substituted or unsubstituted C7 to C20 arylalkyl group, a substituted or unsubstituted C1 to C20 heteroalkyl group, a substituted or unsubstituted C2 to C30 heterocycloalkyl group, a substituted or unsubstituted C2 to C30 heteroaryl group, a substituted or unsubstituted C1 to C4 alkyl ether group, a substituted or unsubstituted C7 to C20 arylakylene ether group, a substituted or unsubstituted C1 to C30 haloalkyl group, or a combination thereof.

In a case where the liquid crystal molecule 310 is included in a content of at least 5 wt % based on the liquid crystal layer 3, the elasticity coefficient of the liquid crystal molecule 310 can be increased, thereby improving contrast ratio (color ratio, CR).

The liquid crystal layer 3 of the curved liquid crystal display may operate according to any one of all types of liquid crystal layers conventionally known, including a twisted nematic (TN) mode, a vertical aligned (VA) mode, an in-plane switching (IPS) mode, a blue phase (BP) mode, and the like.

For example, the liquid crystal molecules 310 may be vertically aligned, and in a case where the liquid crystal layer 3 operates in the VA mode, the band elasticity coefficient K33 of the liquid crystal molecule 310 may be greater than or equal to 15.7×10⁻¹² N. The band elasticity coefficient K33 is measured using a generally-known capacitance-voltage curve. When a voltage is applied to a liquid crystal cell, alignment of liquid crystal molecules 310 is changed and accordingly capacitance is changed, and when the capacitance is measured at this point, the band elasticity coefficient K33 can be fitted by the capacitance-voltage curve.

Alternatively, the liquid crystal molecules 310 may be horizontally aligned, and in a case where the liquid crystal layer 3 operates, for example, in the IPS mode, the twist elasticity coefficient K22 of the liquid crystal molecules 310 may be greater than or equal to 7.7×10⁻¹² N. In general, the twist elasticity coefficient K22 may be measured to be 0.5 times the value of the band elasticity coefficient K33.

For example, in the above Chemical Formula 1, X may be hydrogen, a substituted or unsubstituted C1 to C30 alkyl group, a substituted or unsubstituted C6 to C30 aryl group, a substituted or unsubstituted C1 to C30 alkoxy group, or a combination thereof. More specifically, X may be a substituted or unsubstituted C1 to C10 alkyl group, a substituted or unsubstituted C1 to C10 alkoxy group, or a combination thereof, but is not limited thereto.

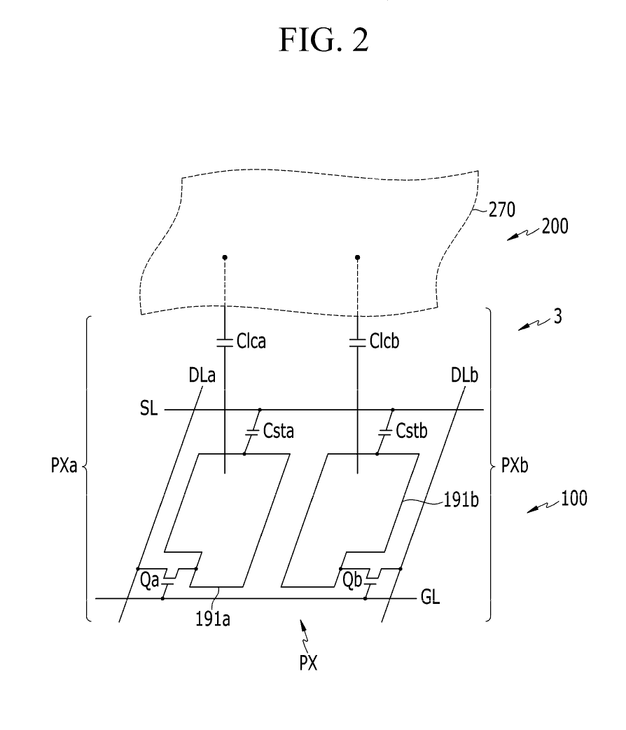

FIG. 2 is an equivalent circuit diagram showing a liquid crystal display according to an exemplary embodiment of the present invention.

Referring to FIG. 2, a liquid crystal display according to an exemplary embodiment of the present invention includes a first substrate 100 and a second substrate 200 facing each other, and a liquid crystal layer 3 interposed therebetween. The first substrate 100 is a thin film transistor array panel, and the second substrate 200 is a common electrode panel.

The liquid crystal display includes signal lines including a plurality of gate lines GL, a plurality of pairs of data lines DLa and DLb, and a plurality of storage electrode lines SL, and a plurality of pixels PX connected to the signal lines.

Each pixel PX includes a pair of subpixels PXa and PXb. The subpixels PXa and PXb include switching elements Qa and Qb, liquid crystal capacitors Clca and Clcb, and storage capacitors Csta and Cstb.

The switching elements Qa and Qb are three-terminal elements such as thin film transistors, which are provided in the lower panel 100. The switching elements Qa and Qb have control terminals connected to a gate line GL, input terminals respectively connected to data lines DLa and DLb, and output terminals respectively connected to the liquid crystal capacitors Clca and Clcb and the storage capacitors Csta and Cstb.

The liquid crystal capacitors Clca and Clcb are formed by using subpixel electrodes 191a and 191b and a common electrode 270 as two terminals, and using the liquid crystal layer 3 between the two terminals as a dielectric material.

The storage capacitors Csta and Cstb that perform auxiliary functions of the liquid crystal capacitors Clca and Clcb are formed so that a storage electrode line SL provided in the lower panel 100 and the subpixel electrodes 191a and 191b are overlapped with an insulator interposed therebetween, and a predetermined voltage such as a common voltage is applied to the storage electrode line SL.

Voltages charged in the two liquid crystal capacitors Clca and Clcb are set to be slightly different from each other. For example, a data voltage applied to the liquid crystal capacitor Clca is set to always be lower or higher than that applied to the liquid crystal capacitor Clcb. If the voltages of the two liquid crystal capacitors Clca and Clcb are appropriately adjusted as described above, it is possible to make an image viewed from a side close to an image viewed from the front, thereby improving the side visibility of the liquid crystal display.

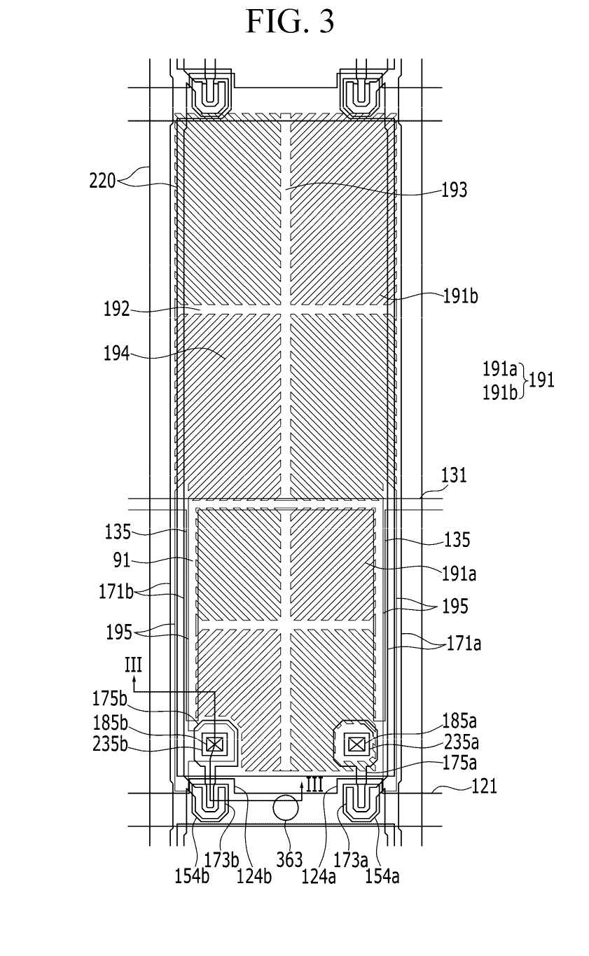

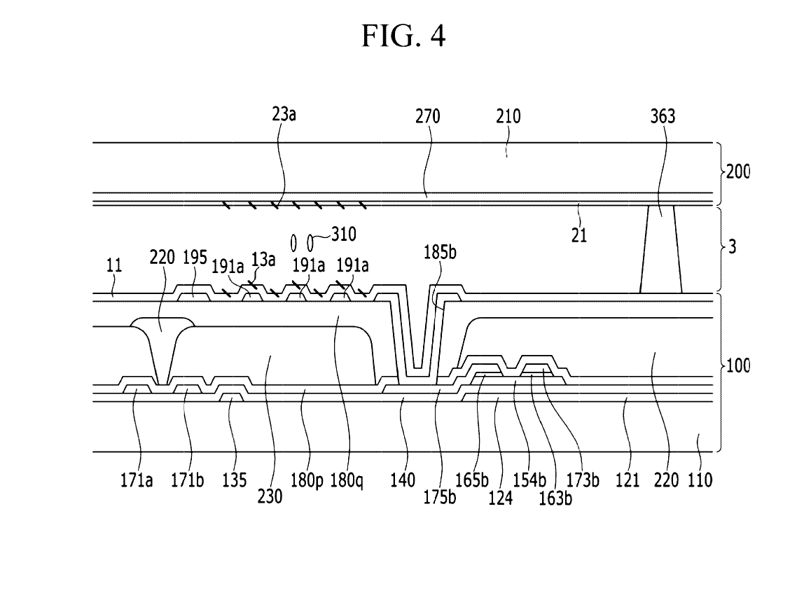

FIG. 3 is a layout view showing a liquid crystal display according to an exemplary embodiment of the present invention, and FIG. 4 is a cross-sectional view taken along cross-sectional line III-III of FIG. 3.

Referring to FIGS. 3 and 4, a liquid crystal display according to an exemplary embodiment of the present invention includes the lower panel 100 and the upper panel 200 facing each other, and the liquid crystal layer 3 interposed between the two panels 100 and 200.

First, the lower panel 100 will be described.

A plurality of gate lines 121 and a plurality of storage electrode lines 131 and 135 are formed on an insulation substrate 110.

The gate line 121 transmits a gate signal and extends in the horizontal direction. Each gate line 121 includes a plurality of first and second gate electrodes 124a and 124b protruding upward.

The storage electrode line 131 includes a stem 131 extending substantially parallel to the gate line 121, and a plurality of storage electrodes 135 extending from the stem 131. The shape and disposition of the storage electrode line 131 and 135 may be modified in various ways.

The gate line 121 and the storage electrode line 131 and 135 may be formed of at least one selected from the group consisting of an aluminum-based metal such as aluminum (Al) or an aluminum alloy, a silver-based metal such as silver (Ag) or a silver alloy, and a copper-based metal such as copper (Cu) or a copper alloy.

Although it has been illustrated in the present exemplary embodiment that the gate line 121 and the gate electrodes 124a and 124b are formed in a single-layer structure, the present invention is not limited thereto. The gate line 121 and the gate electrodes 124a and 124b may be formed in a dual- or triple-layer structure.

In the case of the dual-layer structure, the gate line 121 and the gate electrodes 124 and 124b may include a lower layer and an upper layer, and the lower layer may be formed of at least one selected from the group consisting of molybdenum-based metal such as molybdenum (Mo) or a molybdenum alloy, a chromium-based metal such as chromium (Cr) or a chromium alloy, a titanium-based metal such as titanium (Ti) or a titanium alloy, a tantalum-based metal such as tantalum (Ta) or a tantalum alloy, and a manganese-based metal such as manganese (Mn) or a manganese alloy. The upper layer may be formed of at least one selected from the group consisting of an aluminum-based metal such as aluminum (Al) or an aluminum alloy, a silver-based metal such as silver (Ag) or a silver alloy, and a copper-based metal such as copper (Cu) or a copper alloy. In the case of the triple-layer structure, layers having different physical properties may be combined.

A gate insulating layer 140 is formed over the gate line 121 and the storage electrode lines 131 and 135, and a plurality of semiconductors 154a and 154b made of amorphous or crystalline silicon are formed on the gate insulating layer 140.

A plurality of pairs of ohmic contacts 163b and 165b are formed on the semiconductors 154a and 154b, respectively. The ohmic contacts 163b and 165b may be made of a material such as n+hydrogenated amorphous silicon, doped with a silicide or an n-type impurity at a high concentration.

A plurality of pairs of data lines 171a and 171b and a plurality of pairs of first and second drain electrodes 175a and 175b are formed above the ohmic contacts 163b and 165b and the gate insulating layer 140.

The data lines 171a and 171b transmit a data signal and extend in the vertical direction to intersect the gate line 121 and the stem 131 of the storage electrode line 131. The data lines 171a and 171b include first and second source electrodes 173a and 173b extending toward the first and second gate electrodes 124a and 124b and bent in a U shape, respectively. The first and second source electrodes 173a and 173b are opposite to the first and second drain electrodes 175a and 175b with the first and second gate electrodes 124a and 124b interposed therebetween, respectively.

The data lines 171a and 171b may be formed of at least one selected from the group consisting of an aluminum-based metal such as aluminum (Al) or aluminum alloy, a silver-based metal such as silver (Ag) or silver alloy, and a copper-based metal such as copper (Cu) or copper alloy. Although it has been illustrated in the present exemplary embodiment that the data lines 171a and 171b are formed in a single-layer structure, the present invention is not limited thereto. The data lines 171a and 171b may be formed in a dual- or triple-layer structure.

The first and second drain electrodes 175a and 175b extend upward from one ends partially surrounded by the first and second source electrodes 173a and 173b, respectively. The other end of each of the first and second drain electrodes 175a and 175b may have a wide area to be connected to another layer.

However, in addition to the first and second drain electrodes 175a and 175b, the shape and disposition of the data lines 171a and 171b may be modified in various ways.

The first and second gate electrodes 124a and 124b, the first and second source electrodes 173a and 173b and the first and second drain electrodes 175a and 175b, together with the first and second semiconductors 154a and 154b, form first and second thin film transistors Qa and Qb, respectively. Channels of the first and second thin film transistors Qa and Qb are formed in the first and second semiconductors 154a and 154b between the first and second source electrodes 173a and 173b and the first and second drain electrodes 175a and 175b, respectively.

The ohmic contacts 163b and 165b exist only between the semiconductors 154a and 154 and the data lines 171a and 171b or the drain electrodes 175a and 175b, and reduce the contact resistance therebetween. In the semiconductors 154a and 154b, portions exposed without being covered with the data lines 171a and 171b and the drain electrodes 175a and 175b exist between the source electrodes 173a and 173b and the drain electrodes 175a and 175b, respectively.

A lower passivation layer 180p made of a silicon nitride or a silicon oxide is formed over the data lines 171a and 171b, the drain electrodes 175a and 175b, and the exposed portions of the semiconductors 154a and 154.

Color filters 230 are formed on the lower passivation layer 180p. The color filters 230 may include three color filters of red, green, and blue. A light blocking member 220 made of a single or dual layer of chromium and a chromium oxide or an organic material is formed above the color filters 230. The light blocking member 220 may have openings arranged in a matrix form.

An upper passivation layer 180q made of a transparent organic insulating material is formed over the color filters 230 and the light blocking member 220. The upper passivation layer 180q prevents the color filters 230 from being exposed and provides a flat surface. A plurality of contact holes 185a and 185b respectively exposing the first and second drain electrodes 175a and 175b are formed in the upper passivation layer 180q.

A plurality of pixel electrodes 191 are formed on the upper passivation layer 180q. The pixel electrode 191 may be made of a transparent conductive material such as ITO or IZO, or a reflective metal such as aluminum, silver, chromium, or an alloy thereof.

Each pixel electrode 191 includes first and second subpixel electrodes 191a and 191b separated from each other. Each of the first and second subpixel electrodes 191a and 191b includes a cross-like stem portion consisting of a horizontal stem portion 192 and a vertical stem portion 193 crossing the horizontal stem portion 192. Each of the first and second subpixel electrodes 191a and 191b also includes minute branch portions 194 obliquely extending from the horizontal and vertical stem portions 192 and 193.

Next, the upper panel 200 will be described.

In the upper panel 200, a common electrode 270 is formed on the entire surface of a transparent insulation substrate 210.

A spacer 363 for maintaining a gap between the upper panel 200 and the lower panel 100 is formed in the liquid crystal layer 3.

Alignment layers 11 and 21 are coated on inner surfaces of the lower panel 100 and the upper panel 200, respectively. The alignment layers 11 and 21 may be horizontal or vertical alignment layers. The alignment layers 11 and 21 may be, for example, rubbed or may include an alignment agent or an alignment polymer.

The alignment layers 11 and 21 are, for example, liquid crystal alignment layers made of polyamic acid or polyimide, and may include at least one of generally-used materials. The alignment layers 11 and 21 include aligning polymers 13a and 23a formed by irradiating light onto an alignment auxiliary agent, respectively. The aligning polymer is also referred to as a reactive mesogen.

Polarizers (not shown) may be formed on outer surfaces of the lower panel 100 and the upper panel 200, respectively.

The liquid crystal layer 3 is interposed between the lower panel 100 and the upper panel 200. The liquid crystal layer 3 includes a plurality of liquid crystal molecules 310.

The liquid crystal molecules 310 have negative dielectric anisotropy, and they are aligned so that their major axes are almost perpendicular to the surfaces of the two panels 100 and 200.

In the present exemplary embodiment, the liquid crystal layer 3 may include the liquid crystal molecules 310 formed of a liquid crystal composition according to an exemplary embodiment of the present invention. Specifically, in the present exemplary embodiment, the liquid crystal layer 3 includes the compound represented by Chemical Formula 1 in a content of about not less than 5 wt % based on the entire liquid crystal layer 3.

As the compound is included in the content, the stress of the liquid crystal layer 3 can be minimized even though bending is applied in a process of preparing a curved liquid crystal display. In the case where the liquid crystal molecules 310 are included with the range described above, it is possible to improve the contrast ratio.

If a voltage is applied to the pixel electrode 191 and the common electrode 270, in response to an electric field formed between the pixel electrode 191 and the common electrode 270, the direction of the major axes of the liquid crystal molecules 310 is changed from the direction of the electric field to the vertical direction. The degree of a change in polarization of light incident on the liquid crystal layer 3 is changed depending on the alignment of the liquid crystal molecules 310. The change in the polarization results in a change in transmittance by the polarizers. Accordingly, the liquid crystal display displays an image.

The direction in which the liquid crystal molecules 310 are aligned is determined by the minute branch portions 194, and the liquid crystal molecules 310 are aligned in a direction parallel to the length direction of the minute branch portions 194. One pixel electrode 191 includes four subregions having different length directions of the minute branch portions 194. Therefore, the liquid crystal molecules 310 are aligned in approximately four directions, and four domains having different alignment directions are formed in the liquid crystal layer 3. The direction of the liquid crystal molecules 310 is varied, thereby improving the viewing angle of the liquid crystal display.

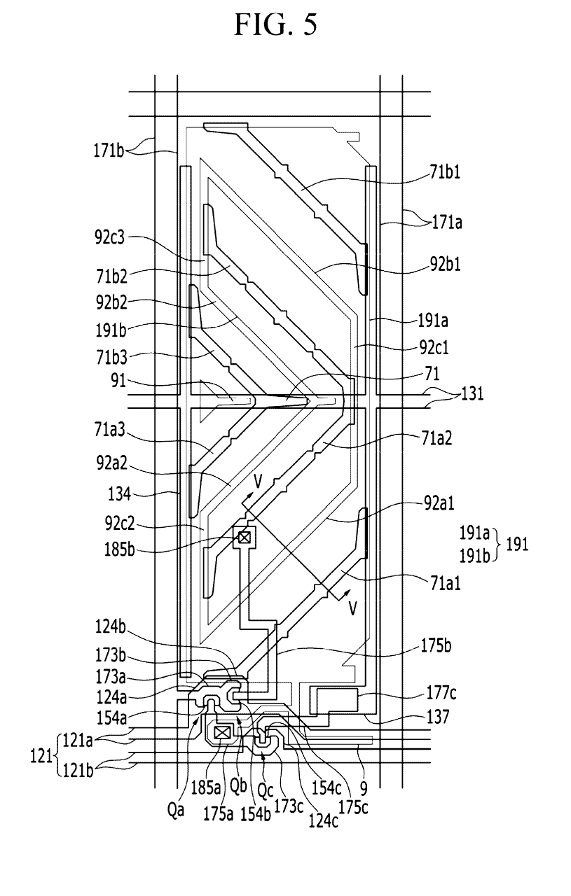

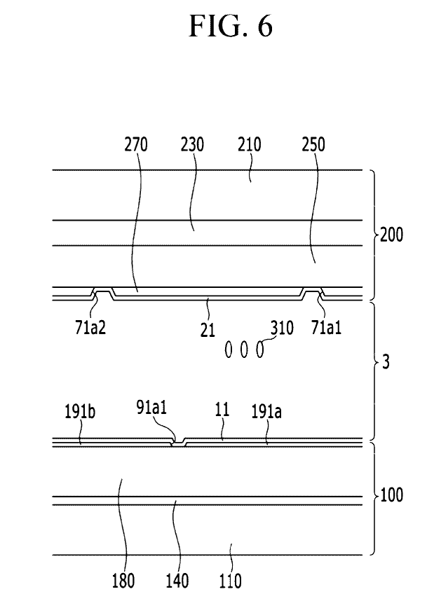

FIG. 5 is a layout view showing a liquid crystal display according to an exemplary embodiment of the present invention, and FIG. 6 is a cross-sectional view taken along cross-sectional line V-V of FIG. 5.

First, a lower panel 100 will be described.

A plurality of gate lines 121 each including a first gate line 121a and a second gate line 121b and a plurality of storage electrode lines 131 are formed on an insulation substrate 110.

The first gate line 121a and the second gate line 121b extend in the horizontal direction and transmit a gate signal. The first gate line 121a includes first and second gate electrodes 124a and 124b protruding upward, and the second gate line 121b includes a third gate electrode 124c. The first and second gate electrodes 124a and 124b are connected to each other to form one protruding portion.

The storage electrode lines 131 also extend in the horizontal direction and transmit a constant voltage such as a common voltage. The storage electrode line 131 includes a pair of vertical portions 134 extending approximately perpendicular to the gate line 121, and a capacitance electrode 137 protruding from the vertical portion 134 and expanding.

A gate insulating layer 140 is formed over the gate lines 121 and the storage electrode lines 131, and a plurality of semiconductor stripes (not shown) made of amorphous or crystalline silicon are formed on the gate insulating layer 140. The semiconductor stripe extends in the vertical direction and extends toward the first and second gate electrodes 124a and 124b. The semiconductor stripe includes first and second semiconductors 154a and 154b connected to each other and a third semiconductor 154c located over the third gate electrode 124c.

A plurality of pairs of ohmic contacts (not shown) are formed above the semiconductors 154a, 154b, and 154c. The ohmic contacts may be made of a material such as n+hydrogenated amorphous silicon, doped with a silicide or an n-type impurity at a high concentration.

A data conductor including a plurality of data lines 171a and 171b, a plurality of first drain electrodes 175a, a plurality of second drain electrodes 175b, and a plurality of third drain electrodes 175c is formed above the ohmic contacts.

The data lines 171a and 171b transmit a data signal and extend in the vertical direction to intersect the first and second gate lines 121a and 121b. The data lines 171a and 171b include first and second source electrodes 173a and 173b extending toward the first and second gate electrodes 124a and 124b to be connected to each other. The first and second source electrodes 173a and 173b are opposite to the first and second drain electrodes 175a and 175b with the first and second gate electrodes 124a and 124b interposed therebetween, respectively.

The first, second, and third drain electrodes 175a, 175b, and 175c each include one end portion having a bar shape and the other end portion having a relatively wide area. The bar-shaped end portions of the first and second drain electrodes 175a and 175b are partially surrounded by the first and second source electrodes 173a and 173b, respectively. The wide end portion of the first drain electrode 175a extends to form a third source electrode 173c bent in a “U” shape. The third source electrode 173c is opposite to the third drain electrode 175c. The wide end portion 177c of the third drain electrode 175c overlaps the capacitance electrode 137, thereby forming a step-down capacitor Cstd. The bar-shaped end portion of the third drain electrode 175c is partially surrounded by the third source electrode 173c.

The first gate electrode 124a, the first source electrode 173a, and the first drain electrode 175a, together with the first semiconductor 154a, form a first thin film transistor Qa, the second gate electrode 124b, the second source electrode 173b, and the second drain electrode 175b, together with the second semiconductor 154b, form a second thin film transistor Qb, and the third gate electrode 124c, the third source electrode 173c, and the third drain electrode 175c, together with the third semiconductor 154c, form a third thin film transistor Qc.

The semiconductor stripe including the first, second, and third semiconductors 154a, 154b, and 154c may have substantially the same plane shape as the data conductor 171a, 171b, 173a, 173b, 173c, 175a, 175b, and 175c and the ohmic contacts therebeneath, with the exception of channel regions between the source electrodes 173, 173b, and 173c and the drain electrodes 175a, 175b, and 175c.

A portion exposed between the first source electrode 173a and the first drain electrode 175a without being covered by the first source electrode 173a and the first drain electrode 175a exists in the first semiconductor 154a, a portion exposed between the second source electrode 173b and the second drain electrode 175b without being covered by the second source electrode 173b and the second drain electrode 175b exists in the second semiconductor 154b, and a portion exposed between the third source electrode 173c and the third drain electrode 175c without being covered by the third source electrode 173c and the third drain electrode 175c exists in the third semiconductor 154c.

A passivation layer 180 made of an inorganic insulator such as a silicon nitride or a silicon oxide is formed over the data conductors 171a, 171b, 173a, 173b, 173c, 175a, 175b, and 175c and the exposed portions of the first, second, and third semiconductors 154a, 154b, and 154c.

However, the passivation layer 180 may be made of an organic insulator and provide a flat surface. The passivation layer 180 may have a dual-layer structure of a lower inorganic layer and an upper organic layer in order to not damage the exposed portions of the semiconductors 154a, 154b, and 154c, while still maintaining excellent insulating characteristics of the organic layer.

A plurality of contact holes 185a and 185b respectively exposing the first and second drain electrodes 175a and 175b are formed in the passivation layer 180.

Pixel electrodes 191 each including first and second subpixel electrodes 191a and 191b and a shielding electrode 9 are formed on the passivation layer 180. The pixel electrode 191 may be made of a transparent conductive material such as ITO or IZO, or a reflective metal such as aluminum, silver, chromium, or alloys thereof.

A transverse center cutout 91, a longitudinal center cutout 92c1, lower cutouts 92a1, 92a2, and 92c2 and upper cutouts 92b1, 92b2, and 92c3 are formed in the pixel electrode 191. The pixel electrode 191 is divided into a plurality of partitions by the cutouts 91, 92c1, 92a1, 92a2, 92c2, 92b1, 92b2, and 92c3. The cutouts 91, 92c1, 92a1, 92a2, 92c2, 92b1, 92b2, and 92c3 are almost inversely symmetrical with respect to an imaginary transverse center line bisecting the pixel electrode 191.

Specifically, the pixel electrode 191 includes oblique portions 92a1, 92a2, 92b1, and 92b2 located at lower and upper portions with respect to the transverse center line, and connecting portions 92c1, 92c2, and 92c3 connecting the oblique portions 92a1, 92a2, 92b1, and 92b2 to each other. The oblique portions 92a1, 92a2, 92b1, and 92b2 obliquely extend approximately from the right edge to the left edge of the pixel electrode 191, and may extend vertically to one another while making an angle of about 45 degrees with the gate lines 121.

The lower portion of the pixel electrode 191 is divided into two partitions by the lower oblique cutouts 92a1 and 92a2, and the upper portion of the pixel electrode 191 is divided into two partitions by the upper oblique cutouts 92b1 and 92b2. Specifically, the lower oblique cutouts 92a1 and 92a2, the upper oblique cutouts 92b1 and 92b2, and the connecting portions 92c1, 92c2, and 92c3 may form a closed circuit, and the pixel electrode 191 may be divided into a first subpixel electrode 191a and a second subpixel electrode 191b by the lower oblique cutouts 92a1 and 92a2, the upper oblique cutouts 92b1 and 92b2, and the connecting portions 92c1, 92c2, and 92c3.

In this instance, the number of partitions or cutouts in the pixel electrode 191 may be varied depending on design factors such as the size of the pixel electrode 191, the ratio of the transverse edges and the longitudinal edges of the pixel electrode 191, and the type and characteristics of a liquid crystal layer 3.

The first and second subpixel electrodes 191a and 191b are connected to the first and second drain electrodes 175a and 175b through the contact holes 185a and 185b, respectively. The first and second subpixel electrodes 191a and 191b are applied with a data voltage from the first and second drain electrodes 175a and 175b.

The first and second subpixel electrodes 191a and 191b receiving the data voltage generate an electric field, together with a common electrode 270 of an upper panel 200, to determine the direction of liquid crystal molecules 310 of the liquid crystal layer 3 between the two electrodes. The liquid crystal molecules 310 of the liquid crystal layer 3, which are aligned vertically to the surfaces of the two electrodes in a state in which there is no electric field, lie in a horizontal direction with respect to the surfaces of the two pixels, and the luminance of light passing through the liquid crystal layer 3 is changed according to the degree of alignment of the liquid crystal molecules 310.

The first subpixel electrode 191a and the common electrode 270, together with the liquid crystal layer 3, form a first liquid crystal capacitor Clca, and the second subpixel electrode 191b, and the common electrode 270, together with the liquid crystal layer 3, form a second liquid crystal capacitor Clcb, to maintain the applied voltage even after the first and second thin film transistors Qa and Qb are turned off.

The first and second subpixel electrodes 191a and 191b overlap the storage electrode lines 131, thereby forming first and second storage capacitors Csta and Cstb. The first and second storage capacitors Csta and Cstb reinforce the voltage storage capacity of the first and second liquid crystal capacitors Clca and Clcb.

The capacitance electrode 137 and the wide end portion 177c of the third drain electrode 175c overlap each other with the gate insulating layer 140 and the semiconductor interposed therebetween, thereby forming the step-down capacitor Cstd. However, the semiconductor disposed between the capacitance electrode 137 and the wide end portion 177c of the third drain electrode 175c may be removed.

Hereinafter, the upper panel 200 will be described.

A light blocking member (not shown) is formed on an insulation substrate 210 made of transparent glass or plastic. The light blocking member is also referred to as a black matrix, and prevents light leakage between the pixel electrodes 191. The light blocking member has a plurality of openings (not shown) which are opposite to the pixel electrodes 191 and have almost the same shape as the pixel electrodes 191. However, the light blocking member may consist of portions corresponding to the gate lines 121a and 121b and the data lines 171a and 171b, and portions corresponding to the thin film transistors.

A plurality of color filters 230 are formed on the substrate 210. The color filters 230 mostly exist within the region surrounded by the light blocking member, and may extend along the columns of the pixel electrodes 191 in the vertical direction. Each color filter 230 may display one of primary colors such as red, green, and blue.

An overcoat 250 is formed over the color filters 230. The overcoat 250 may be made of an organic material. The overcoat 250 prevents the color filters 230 from being exposed and provides a flat surface. The overcoat 250 may be omitted.

The common electrode 270 is formed on the overcoat 250. The common electrode 270 is made of a transparent conductor such as ITO or IZO. The common electrode 270 includes a set of a plurality of cutouts 71, 71a1, 71a2, 71a3, 71b1, 71b2, and 71b3.

The set of the plurality of cutouts 71, 71a1, 71a2, 71a3, 71b1, 71b2, and 71b3 include a center cutout 71, first to third lower oblique cutouts 71a1, 71a2, and 71a3 and first to third upper oblique cutouts 71b1, 71b2, and 71b3.

The cutouts 71, 71a1, 71a2, 71a3, 71b1, 71b2, and 71b3 are respectively disposed between the neighboring cutouts 92a1, 92a2, 92b1, and 92b2 of the pixel electrode 191 or between the cutouts 92a1, 92a2, 92b1, and 92b2 of the pixel electrode 191, and the edge of the pixel electrode 191.

The set of the plurality of cutouts 71, 71a1, 71a2, 71a3, 71b1, 71b2, and 71b3 is almost inversely symmetrical with respect to the imaginary transverse center line of the pixel electrode 191.

The cutouts of the pixel electrode 19 land the cutouts of the common electrode 270 divide the pixel electrode 191 into a plurality of sub-areas, and each sub-area has two primary edges making an oblique angle with the primary edge of the pixel electrode 191. Liquid crystal molecules 310 in each sub-area are mostly inclined in directions perpendicular to the primary edges. The directions in which the liquid crystal molecules 310 are inclined include approximately four directions.

By varying the directions in which the liquid crystal molecules 310 are inclined as described above, the reference viewing angle of the liquid crystal display can be increased.

Alignment layers 11 and 21 are coated on inner surfaces of the lower panel 100 and the upper panel 200, respectively. The alignment layers 11 and 21 may be vertical alignment layers. Specifically, the alignment layers 11 and 21 may be located over the pixel electrodes 191 and the common electrode 270, respectively.

Polarizers (not shown) may be formed on outer surfaces of the lower panel 100 and the upper panel 200, respectively. The transmissive axes of the polarizers intersect each other, and one transmissive axis is preferably parallel to the gate lines 121. In the case of a reflective liquid crystal display, one of two polarizers may be omitted.

The liquid crystal layer 3 is interposed between the lower panel 100 and the upper panel 200. The liquid crystal layer 3 includes a plurality of liquid crystal molecules 310.

The liquid crystal molecules 310 have negative dielectric anisotropy. The liquid crystal molecules 310 are aligned so that their major axes are almost perpendicular to the surfaces of the two panels 100 and 200.

In the present exemplary embodiment, the liquid crystal layer 3 includes liquid crystal molecules 310 formed of a liquid crystal composition according to an exemplary embodiment of the present invention.

Specifically, in the present exemplary embodiment, the liquid crystal layer 3 includes the compound represented by Chemical Formula 1 in a content of about not less than 5 wt % based on the entire liquid crystal layer 3.

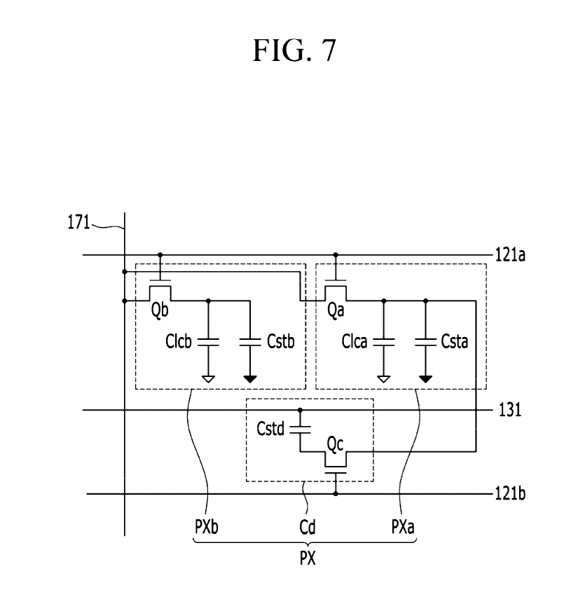

FIG. 7 is an equivalent circuit diagram showing a pixel of the liquid crystal display shown in FIG. 4. A circuit structure and operation of the liquid crystal display shown in FIG. 4 will be described with reference to FIG. 6.

A liquid crystal display according to an exemplary embodiment of the present invention includes signal lines including a first gate line 121a, a second gate line 121b, a storage electrode line 131, and a data line 171, and a pixel PX connected to the signal lines.

The pixel PX includes a first subpixel PXa, a second subpixel PXb, and a step-down portion Cd.

The first subpixel PXa includes a first switching element Qa, a first liquid crystal capacitor Clca, and a first storage capacitor Csta. The second subpixel PXb includes a second switching element Qb, a second liquid crystal capacitor Clcb, and a second storage capacitor Cstb. The step-down portion Cd includes a third switching element Qc and a step-down capacitor Cstd.

The first and second switching elements Qa and Qb are three-terminal elements such as thin film transistors, which are provided in the lower panel. The first and second switching elements Qa and Qb have control terminals connected to the first gate line 121a, input terminals connected to the data line 171, and output terminals respectively connected to the first and second liquid crystal capacitors Clca and Clcb and the first and second storage capacitors Csta and Cstb.

The third switching element Qc is also a three-terminal element such as a thin film transistor, which is provided in the lower panel. The third switching element Qc has a control terminal connected to the second gate line 121b, an input terminal connected to the first liquid crystal capacitor Clca, and an output terminal connected to the step-down capacitor Cstd.

The first and second liquid crystal capacitors Clca and Clcb are formed by overlapping the first and second subpixel electrodes 191a and 191b connected to the first and second switching elements Qa and Qb and the common electrode of the upper panel. The first and second storage capacitors Csta and Cstb are formed by overlapping the storage electrode line 131 and the first and second subpixel electrodes 191a and 191b.

The step-down capacitor Cstd is connected to the output terminal of the third switching element Qc and the storage electrode line 131. The step-down capacitor Cstd is formed by overlapping the storage electrode line 131 provided in the lower panel and the output terminal of the third switching element Qc with an insulator interposed therebetween.

An operation of the liquid crystal display shown in FIG. 6 will now be described.

First, if a gate-on voltage is applied to the first gate line 121a, the first and second thin film transistors Qa and Qb connected to the first gate line 121a are turned on.

Accordingly, a data voltage of the data line 171 is simultaneously applied to the first and second subpixel electrodes 191a and 191b through the first and second switching elements Qa and Qb that are turned on. The first and second liquid crystal capacitors Clca and Clcb are charged with the same voltage value as a difference between the common voltage of the common electrode 270 and the voltage of the first and second subpixel electrodes 191a and 191b, and thus the charged voltages of the first and second liquid crystal capacitors Clca and Clcb equal each other. In this instance, a gate-off voltage is applied to the second gate line 121b.

Next, if the gate-off voltage is applied to the first line 121a and simultaneously the gate-on voltage is applied to the second gate line 121b, the first and second switching elements Qa and Qb connected to the first gate line 121a are turned off, and the third switching element Qc is turned on. Accordingly, charges of the first subpixel electrode 191a connected to the output terminal of the first switching element Qa flows in the step-down capacitor Cstd, so that the voltage of the first liquid crystal capacitor Clca falls.

The case where the liquid crystal display according to the present exemplary embodiment is driven in frame inversion and a data voltage having a positive (+) polarity is applied to the data line 171 based on the common voltage will be described as an example. Negative (−) charges are gathered in the step-down capacitor Cstd after the previous frame is finished. In the present frame, if the third switching element Qc is turned on, positive (+) charges of the first subpixel electrode 191a flow in the step-down capacitor Cstd through the third switching element Qc. Thus, the positive (+) charges are gathered in the step-down capacitor Cstd, and the voltage of the first liquid crystal capacitor Clca falls. In the next frame, as the third switching element Qc is turned on in a state in which the first subpixel electrode 191a is charged with negative (−) charges, the negative (−) charges of the first subpixel electrode 191a flow in the step-down capacitor Cstd. Thus, the negative (−) charges are gathered in the step-down capacitor Cstd, and the voltage of the first liquid crystal capacitor Clca also falls.

As described above, according to the present exemplary embodiment, the charged voltage of the first liquid crystal capacitor Clca can always be lower than that of the second liquid crystal capacitor Clcb regardless of the polarity of the data voltage. Thus, the charged voltages of the first and second liquid crystal capacitors Clca and Clcb are different from each other, thereby improving the side visibility of the liquid crystal display.

Unlike the present exemplary embodiment, the first and second switching elements Qa and Qb of the first and second subpixel electrodes 191a and 191b may be applied with different data voltages obtained from one image information set through different data lines, respectively. Alternatively, the first and second switching elements Qa and Qb of the first and second subpixel electrodes 191a and 191b may be connected to different gate lines to be applied with different data voltages obtained from one image information set at different times, respectively. Alternatively, only the first subpixel electrode 191a may be applied with a data voltage through the switching element, and the second subpixel electrode 191b may be applied with a relatively low voltage through capacitive coupling to the first subpixel electrode 191a. In some exemplary embodiments, the third switching element Qc, the step-down capacitor Cstd, and the like may be omitted.

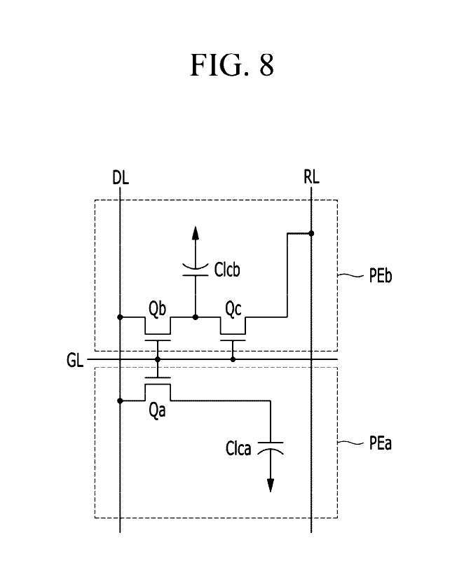

FIG. 8 is an equivalent circuit diagram showing a pixel of a liquid crystal display according to an exemplary embodiment of the present invention.

Referring to FIG. 8, one pixel PX of a liquid crystal display according to an exemplary embodiment of the present invention includes a plurality of signal lines including a gate line GL transmitting a gate signal, a data line DL transmitting a data signal and a reference voltage line transmitting a divided reference voltage, and a first switching element Qa, a second switching element Qb, a third switching element Qc, a first liquid crystal capacitor Clca, and a second liquid crystal capacitor Clcb, which are connected to the plurality of signal lines.

The first and second switching elements Qa and Qb are connected to the gate line GL and the data line DL, respectively. The third switching element Qc is connected to an output terminal of the second switching element Qb and the reference voltage line RL.

The first and second switching elements Qa and Qb are three-terminal elements such as thin film transistors. The first and second switching elements Qa and Qb have control terminals connected to the gate line GL and input terminals connected to the data line DL. An output terminal of the first switching element Qa is connected to the first liquid crystal capacitor Clca, and an output terminal of the second switching element Qb is connected to an output terminal of the third switching element Qc.

The third switching element Qc is also a three-terminal element such as a thin film transistor. The third switching element Qc has a control terminal connected to the gate line GL, the output terminal connected to the second liquid crystal capacitor Clcb, and an input terminal connected to the reference voltage line RL.

If a gate-on signal is applied to the gate line GL, the first, second, and third switching elements Qa, Qb, and Qc connected to the gate line GL are turned on. Accordingly, data voltages applied to the data line DL are applied to a first subpixel electrode PEa and a second subpixel electrode PEb through the first and second switching elements Qa and Qb which are turned on, respectively. In this instance, the data voltages applied to the first and second subpixel electrodes PEa and PEb may be charged as values that are equal to each other. However, according to an exemplary embodiment of the present invention, the voltage applied to the second subpixel electrode PEb is divided through the third switching element Qc connected in parallel to the second switching element Qb. Therefore, the voltage applied to the second subpixel electrode PEb may be smaller than that the voltage applied to the first subpixel electrode PEa.

As a result, the voltages charged in the first and second liquid crystal capacitors Clca and Clcb are different from each other. Since the voltages charged in the first and second liquid crystal capacitors Clca and Clcb are different from each other, the angles at which liquid crystal molecules 310 are aligned in first and second subpixels are different from each other, and accordingly, the luminances of the two subpixels are different. Thus, if the voltages charged in the first and second liquid crystal capacitors Clca and Clcb are appropriately adjusted, it is possible to make an image viewed from a side maximally close to an image viewed from the front, thereby improving the side visibility of the liquid crystal display.

The exemplary embodiment of FIG. 8 is obtained by modifying the visibility structure in the exemplary embodiments of FIGS. 3 and 5, and the liquid crystal composition included in the liquid crystal layer 3 described above may be applied to the present exemplary embodiment.

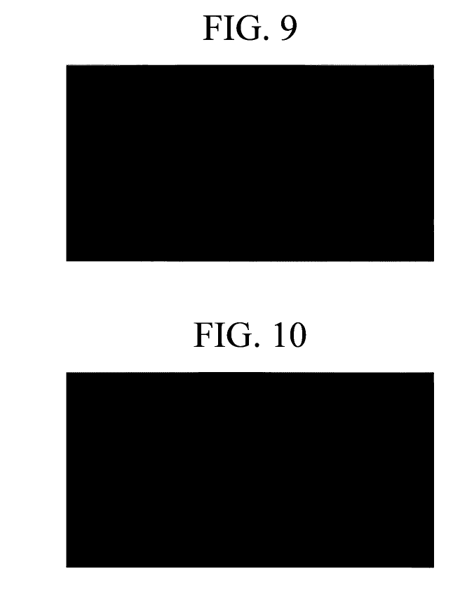

FIGS. 9 and 10 are drawings showing an effect that the contrast ratio of a curved liquid crystal display is improved according to an exemplary embodiment of the present invention. FIG. 9 is a drawing showing light leakage of a curved liquid crystal display including a liquid crystal layer 3 containing less than 5 weight % of a liquid crystal molecule 310 represented by Chemical Formula 1. FIG. 10 is a drawing showing light leakage of a curved liquid crystal display including a liquid crystal layer 3 containing not less than 5 weight % of a liquid crystal molecule 310 represented by Chemical Formula 1.

The curved liquid crystal display in FIG. 9 contains the liquid crystal molecules 310 represented by Chemical Formula 1 in the content of less than 5 weight %, and the band elasticity coefficient K33 of liquid crystals is 13×10⁻¹² N. The curved liquid crystal display in FIG. 10 contains the liquid crystal molecules 310 represented by Chemical Formula 1 in the content of not less than 5 weight %, and band elasticity coefficient K33 of liquid crystals is 15.7×10⁻¹² N.

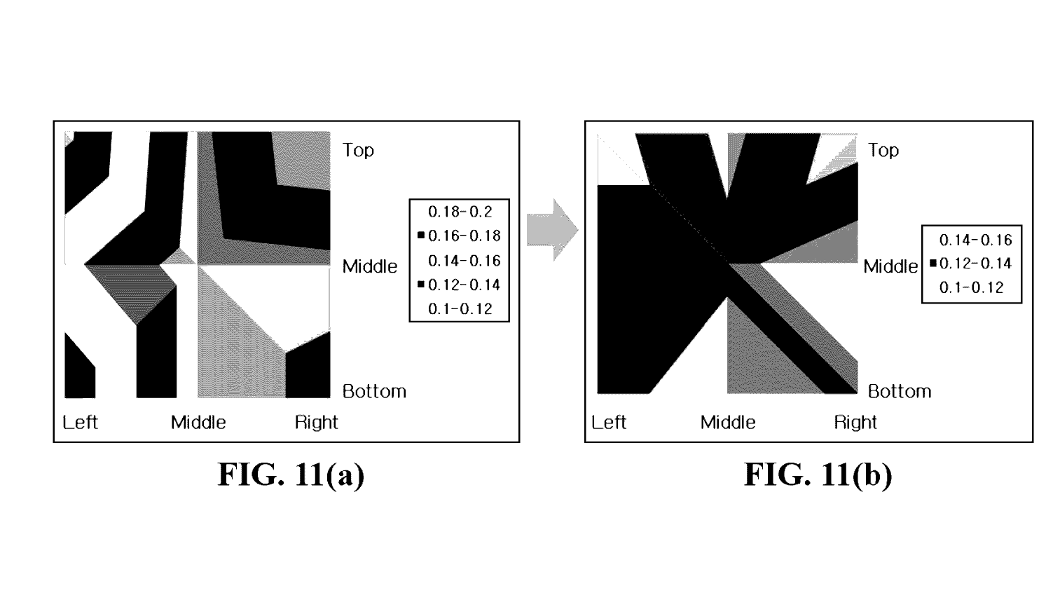

FIG. 11A is a reference view illustrating the contrast ratios of the conventional curved liquid crystal display and FIG. 11B is the improved curved liquid crystal display, and contour data indicate black luminance measured for each location of the top, middle, down, left, center, and right of the panel.

Since a contrast ratio indicates white luminance/black luminance, the contrast ratio is increased as the black luminance is decreased.

FIG. 11A shows a measurement result of black luminance in a conventional curved panel, and FIG. 11B shows a measurement result of black luminance of a panel where the liquid crystal according to the exemplary embodiment is inserted.

Referring to FIG. 11B, the black luminance of the curved liquid crystal display in FIG. 10 is decreased about 20% and thus the contrast ratio is increased about 20%. That is, the contrast ratio of the liquid crystal display in FIG. 10 containing not less than 5 weight % of the liquid crystal molecules 310 represented by Chemical Formula 1 is improved by about 20% as compared with the case of the curved liquid crystal display in FIG. 9.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | | | |
|---|---|---|---|
| 1000 | curved liquid crystal | 3 | liquid crystal layer |
| | display | | |
| 13a, 23a | alignment polymer | 100 | lower panel |
| 121 | gate line | 140 | gate insulating layer |
| 154a, 154b | semiconductor | 163b, 165b | ohmic contact |
| 171a, 171b | data line | 173a, 173b | source electrode |
| 175a, 175b | drain electrode | 200 | upper panel |
| 230 | color filter | 270 | common electrode |
| 310 | liquid crystal molecule | | |

1. A curved liquid crystal display, comprising:
a first substrate;
a second substrate opposite to the first substrate; and
a liquid crystal layer comprising liquid crystal molecules interposed between the first and second substrates, the liquid crystal layer containing not less than 5 wt % the liquid crystal molecules represented by the following Chemical Formula 1: 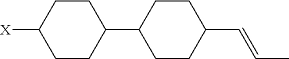
where X being
a hydrogen atom
a hydroxyl group,
a substituted or unsubstituted amino group,
a halogen atom, an oxygen atom,
a substituted or unsubstituted C1 to C30 alkyl group, a substituted or unsubstituted C6 to C30 aryl group, a substituted or unsubstituted C1 to C30 alkoxy group,
a substituted or unsubstituted C3 to C30 cycloalkenyl group,
a substituted or unsubstituted C1 to C20 alkylamine group,
a substituted or unsubstituted C7 to C20 arylalkyl group,
a substituted or unsubstituted C1 to C20 heteroalkyl group,
a substituted or unsubstituted C2 to C30 heterocycloalkyl group,
a substituted or unsubstituted C2 to C30 heteroaryl group,
a substituted or unsubstituted C1 to C4 alkyl ether group,
a substituted or unsubstituted C7 to C20 arylakylene ether group,
a substituted or unsubstituted C1 to C30 haloalkyl group, or
a combination thereof.

2. The curved liquid crystal display of claim 1, the liquid crystal molecules having a band elasticity coefficient K33 not less than 15.7×10⁻¹² N in a vertical aligned (VA) mode.

3. The curved liquid crystal display of claim 1, the liquid crystal molecules having a twist elasticity coefficient K22 not less than 7.7×10⁻¹² N in an in-plane switching (IPS) mode.

4. The curved liquid crystal display of claim 1, further comprising field generating electrodes formed on at least one of the first and second substrates.

5. The curved liquid crystal display of claim 4, further comprising an alignment layer located over the field generating electrodes,
the alignment layer comprising an aligning agent and an aligning polymer, and
the aligning polymer being formed by irradiating light onto the aligning agent and an alignment auxiliary agent.

6. The curved liquid crystal display of claim 4,
the first substrate being a thin film transistor substrate and
the second substrate being a common electrode substrate, and
at least one of a color filter and a black matrix being formed on the thin film transistor substrate.

7. The curved liquid crystal display of claim 4, the field generating electrodes comprising
pixel electrodes comprising first cutouts, located on the first substrate; and
a common electrode comprising second cutouts, located on the second substrate,
the first cutouts are arranged to cross the second cutouts.

8. The curved liquid crystal display of claim 1, the liquid crystal molecules being horizontally or vertically aligned in a state in which no electric field is applied.

9. The curved liquid crystal display of claim 1, further comprised of X being
hydrogen,
a substituted or unsubstituted C1 to C30 alkyl group,
a substituted or unsubstituted C6 to C30 aryl group,
a substituted or unsubstituted C1 to C30 alkoxy group, or
a combination thereof.

10. The curved liquid crystal display of claim 6, the at least one of a color filter and a black matrix being located between the liquid crystal layer and the second substrate.

11. The curved liquid crystal display of claim 6, the at least one of a color filter and a black matrix being located between the liquid crystal layer and the first substrate.

12. A curved liquid crystal display, comprising:
a first substrate;
a second substrate opposite to the first substrate;
at least one of a color filter and a black matrix being formed on the first substrate; and
a liquid crystal layer comprising liquid crystal molecules interposed between the first and second substrates,
the liquid crystal molecules having a twist elasticity coefficient K22 not less than 7.7×10⁻¹² N in an in-plane switching (IPS) mode,
the liquid crystal layer containing not less than 5 wt % of the liquid crystal molecules represented by the following Chemical Formula 1: 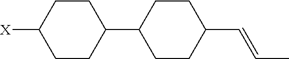
where X being
a hydroxyl group,
a substituted or unsubstituted amino group,
a halogen atom, an oxygen atom,
a substituted or unsubstituted C3 to C30 cycloalkenyl group,
a substituted or unsubstituted C1 to C20 alkylamine group,
a substituted or unsubstituted C7 to C20 arylalkyl group,
a substituted or unsubstituted C1 to C20 heteroalkyl group,
a substituted or unsubstituted C2 to C30 heterocycloalkyl group,
a substituted or unsubstituted C2 to C30 heteroaryl group,
a substituted or unsubstituted C1 to C4 alkyl ether group,
a substituted or unsubstituted C7 to C20 arylakylene ether group,
a substituted or unsubstituted C1 to C30 haloalkyl group, or
a combination thereof.
